(19) United States
(12) Patent Application Publication
(10) Pub. No.: US 2011/0238889 A1
(43) Pub. Date: Sep. 29, 2011

(54) SEMICONDUCTOR MEMORY DEVICE FROM WHICH DATA CAN BE READ AT LOW POWER

(76) Inventors: Makoto Miakashi, Kawasaki-shi (JP); Noboru Shibata, Kawasaki-shi (JP)

(21) Appl. No.: 12/884,648

(22) Filed: Sep. 17, 2010

(30) Foreign Application Priority Data
Mar. 24, 2010 (JP) 2010-068932

(51) Int. Cl. G06F 12/00; G06F 12/02

(52) U.S. Cl. 711/103; 711/E12.001; 711/E12.008

(57) ABSTRACT

According to one embodiment, a semiconductor memory device includes a memory cell array and a control circuit. The memory cell array is composed of a plurality of memory cells arranged in a matrix pattern. The control circuit sets a first flag data in a second memory cell in order to write data to a plurality of first memory cells of memory cell array, the second memory cell having been selected at the same time as the first memory cells, determines whether the first flag data is set in the second memory cell before data is read from the first memory cells, and reads no data from the first memory cells and outputs data of first logic level if the first flag data is not set in the second memory cell, and reads data from the first memory cells if the first flag data is set in the second memory cell.

### CROSS-REFERENCE TO RELATED APPLICATIONS

This application is based upon and claims the benefit of priority from Japanese Patent Application No. 2010-068932, filed Mar. 24, 2010; the entire contents of which are incorporated herein by reference.

### FIELD

Embodiments described herein relate generally to a semiconductor memory device, more particularly to a technique of reading data from a NAND flash memory.

### BACKGROUND

In a NAND flash memory, data is written to a plurality of memory cells selected by word lines, in units of pages. The data thus written is read in units of pages, from the memory cells selected by word lines.

From the NAND flash memory, data is read in units of pages. The data is therefore read from all memory cells selected, whether data is written in the memory cells or not. A memory cell no data is written into, however, has a low threshold voltage. Therefore, the current for reading data from the memory cell to which no data is written is required greater than the current for reading data from the memory cell to which data is written. This increases the power the NAND flash memory consumes. A demand is therefore made for a semiconductor memory device from which data can be read at low power.

As a related technique, nonvolatile semiconductor memory devices have been developed, to which data can be written at high speed at low power consumption. (See, for example, Jpn. Pat. Appln. KOKAI Publication No. 6-259320.)

### BRIEF DESCRIPTION OF THE DRAWINGS

FIG. 1 is a configuration diagram showing an exemplary semiconductor memory according to an embodiment;

FIG. 2 is a circuit diagram showing an example of the memory cell array shown in FIG. 1, and an example of the bit line control circuit shown in FIG. 1;

FIG. 3 is a configuration diagram showing an exemplary page according to a first embodiment;

FIGS. 4A and 4B are diagrams showing an exemplary threshold voltage distribution in a memory cell that stores two level data;

FIG. 5 is a flowchart schematically illustrating a data write process performed in the first embodiment;

FIG. 6 is a flowchart schematically illustrating a data read process performed in the first embodiment;

FIG. 7 is a diagram showing an exemplary threshold voltage distribution in a memory cell that stores four level data;

FIG. 8 is a configuration diagram showing an exemplary page according to a second embodiment;

FIG. 9 is a flowchart schematically illustrating a data write process performed in the second embodiment;

FIGS. 10A, 10B and 10C are diagrams showing an exemplary threshold voltage distribution in a first flag cell;

FIGS. 11A, 11B and 11C are diagrams showing an exemplary threshold voltage distributions in a second flag cell;

FIG. 12 is a flowchart schematically illustrating a data read process performed in the second embodiment;

FIG. 13 is a flowchart schematically illustrating a different data read process performed in the second embodiment; and

FIG. 14 is a flowchart schematically illustrating a data read process performed in a third embodiment.

### DETAILED DESCRIPTION

In general, a semiconductor memory according to one embodiment includes a memory cell array and a control circuit. The memory cell array has a plurality of memory cells arranged in a matrix pattern. To write data to a plurality of first memory cells of the memory cell array, the control circuit sets first flag data in a second memory cell selected at the same time as the plurality of first memory cells. In order to read data from the plurality of first memory cells, the control circuit determines whether the first flag data is set in the second memory cell. If the first flag data is not set in the second memory cell, the control circuit does not read data from the plurality of first memory cells, and reads data at first logic level. If the first flag data is set in the second memory cell, the control circuit reads data from the plurality of first memory cells.

Embodiments will be described with reference to the accompanying drawings.

### First Embodiment

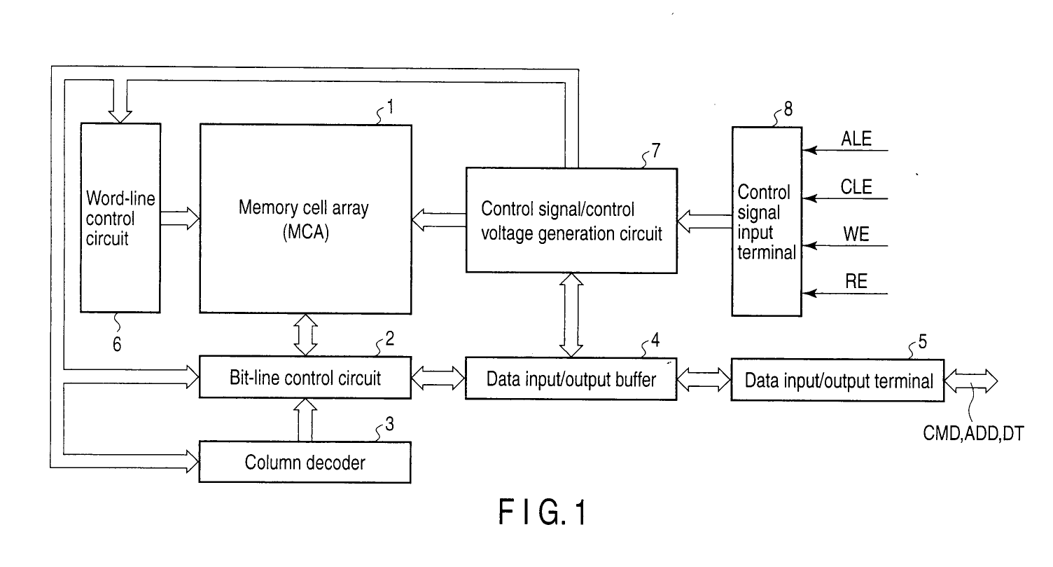

FIG. 1 shows the configuration of a semiconductor memory according to a first embodiment, such as NAND flash memory that can store, for example, two levels (1 bit) or four levels (2 bits).

The memory has a memory cell array 1, which includes a plurality of bit lines, a plurality of word lines, and a common source line. The memory cell array 1 has memory cells arranged in a matrix pattern. The memory cells are, for example, electrically erasable and programmable ROM (EEPROM) cells. To the memory cell array 1, a bit-line control circuit 2 and a word-line control circuit 6 are connected to control bit lines and word lines, respectively.

The bit-line control circuit 2 reads data through the bit lines from the memory cells of the memory cell array 1, detects through the bit lines the storage states of the memory cells of the memory cell array 1, and applies through the bit lines a write control voltage to the memory cells of the memory cell array 1. Data is thereby written to the memory cells. To the bit-line control circuit 2, a column decoder 3 and a data input/output buffer 4 are connected. The bit-line control circuit 2 incorporates a data storage circuit, which is selected by the column decoder 3. The data read from any memory cell to the data storage circuit is output through the data input/output buffer 4 to a data input/output terminal 5. From the data input/output terminal 5, the data is output to an external apparatus. The data input/output terminal 5 is connected to a host (not shown) provided outside, for example, the memory chip. The host is constituted by, for example, a microcomputer, and receives the data output from the data input/output terminal 5. The host further outputs various commands CMDs, addresses ADDs and data DT. The write data input from the host to the data input/output terminal 5 is supplied through the data input/output buffer 4 to the data storage circuit selected by the column decoder 3. The commands and the addresses are supplied to a control signal/control voltage generation circuit 7.

The word-line control circuit 6 is connected to the memory cell array 1. The word-line control circuit 6 selects at least one word line of the memory cell array 1 and applies a voltage to the selected word line, thereby to write data or erase data.

The memory cell array 1, bit-line control circuit 2, column decoder 3, data input/output buffer 4 and word-line control circuit 6 are connected to the control signal/control voltage generation circuit 7, and controlled by the control signal/control voltage generation circuit 7. The control signal/control voltage generation circuit 7 is connected to a control signal input terminal 8 and is controlled by the control signals ALE (address latch enable), CLE (command latch enable), WE (write enable) and RE (read enable) supplied from the host through the input terminal 8.

The bit-line control circuit 2, column decoder 3, word-line control circuit 6 and control signal/control voltage generation circuit 7 constitute a write circuit, a read circuit and an erase circuit.

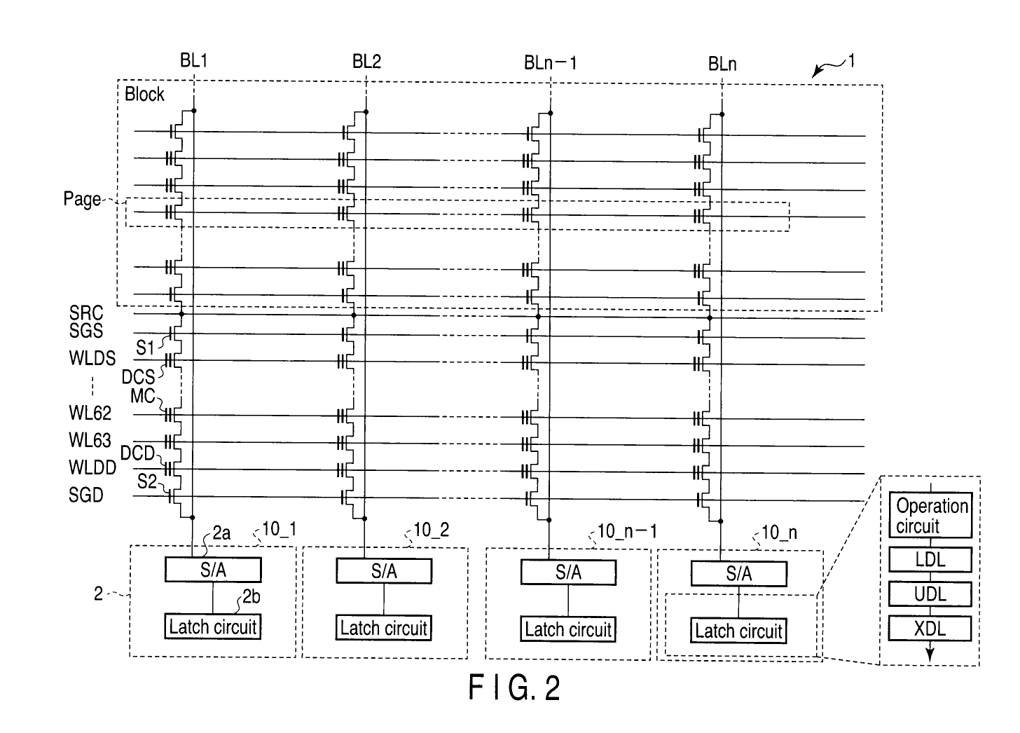

FIG. 2 shows the configuration of the memory cell array 1 and the configuration of the bit-line control circuit 2.

As shown in FIG. 2, a plurality of NAND strings are arranged in the memory cell array 1. One of the NAND strings are composed of, for example, 64 memory cells MC (i.e., EEPROM cells), dummy cells DSC and DCD, and selection gates S1 and S2. The selection gate S2 is connected to a bit line BL1, and the selection gate S1 is connected to a source line SRC. The other NAND strings are connected to bit lines BL2, and to the source lines SRC.

The memory cells MC arranged in each row have their gates connected to one word line, WL0, WL1, . . . or WL63 (WL0 not shown in FIG. 2). The dummy cells DSC and DCD are connected to dummy word lines WLDS and WLDD, respectively. The selection gates S2 of the memory cells MC of each row are connected in common to a select line SGS, and the selection gates S1 of the memory cells of each row are connected in common to a select line SGS.

The memory cell array 1 includes a plurality of cell blocks, each indicated by a broken-line box. Each cell block is composed of a plurality of NAND strings. In the memory cell array 1, data is erased, for example in units of cell blocks. Of the memory cells forming one block, those connected to one work line constitute one page indicated by a small broken-line box. The memory cells connected to one word line constitute one page if each memory cell stores, for example, two level data, and two pages if each memory cell stores, for example, four level data.

The bit lines BL1, BL2, BLn−1 and BLn are connected to data storage circuits 10 1, 10 2, . . . , 10 n−1 and 10 n, respectively. Each of the data storage circuits 10 1, 10 2, . . . , 10 n−1 and 10 n is composed of a sense amplifier (S/A) 2a and a latch circuit 2b.

The sense amplifier 2a detects the data or flag data read from the memory cells. The latch circuit 2b is connected to the sense amplifier 2a.

The larch circuit 2b is composed of, for example, an operation circuit and three latch circuits LDL, UDL and XDL. The operation circuit can invert the data items held in the latch circuits LDL, UDL and XDL and perform a logic operation such as exclusive OR. The latch circuits LDL, UDL and XDL hold the data to be written to memory cells and the data detected by the sense amplifier 2a. Of the latch circuits LDL, UDL and XDL, the latch circuit XDL is connected to the data input/output buffer 4 and holds the data to input to the data input/output buffer 4 or the data output from the data input/output buffer 4.

The sense amplifier 2a and latch circuits 2b of each data storage circuit are controlled by the column decoder 3 and control signal/control voltage generation circuit 7 as shown in FIG. 1.

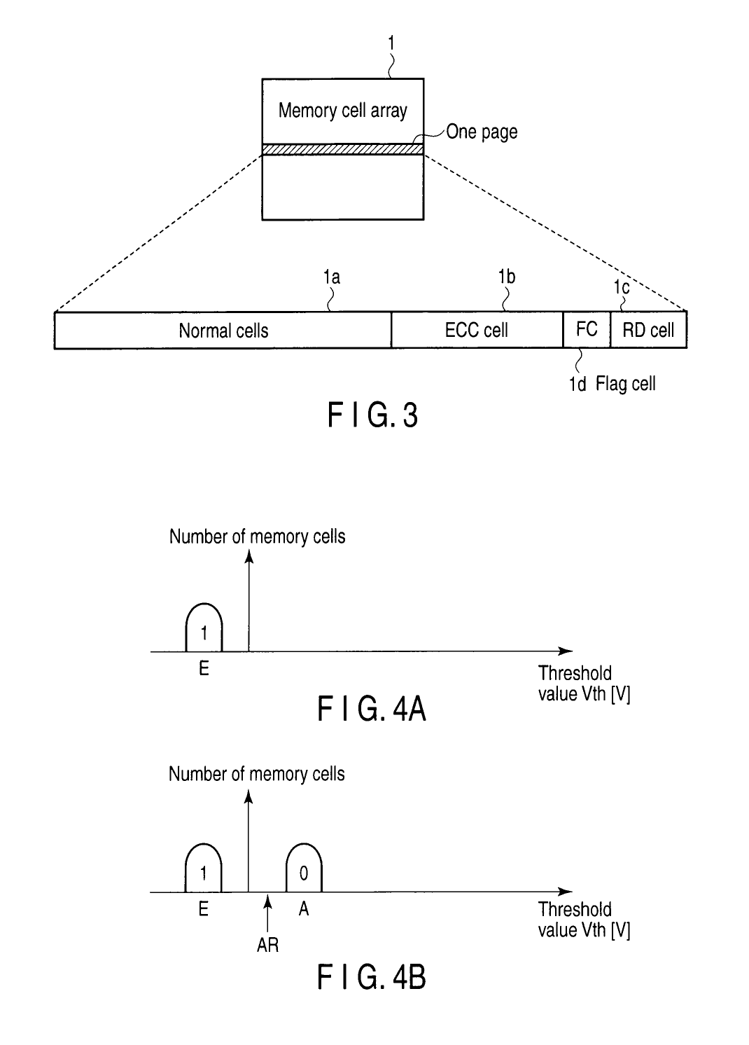

FIG. 3 shows an exemplary configuration of that part of the memory cell array 1, which constitute one page. One page is constituted by normal cells 1a for storing, for example, user data, error correction code (ECC) cells 1b for achieving error correction, redundancy (RD) cells 1c to use in place of defective cells, and a flag cell (FC) 1d for achieving write detection. Only one flag cell 1d is provided, holding one bit. Nonetheless, two or more flag cells 1d may be provided, as will be explained later.

In the first embodiment, two level data (one bit of data) is written to, and read from, each memory cell. Therefore, if the flag data set in the flag cell 1d is “1,” it indicates that the page has been erased, or not written at all, and if the flag data is “0,” it indicates that the page is written.

How the first embodiment operates will be explained. The process of reading data is performed on any page to which data has been written, not on any page to which no data has been written. Whether data has been written or not to a page is determined from the data held in the flag cell 1d. This is why data is written to the flag cell 1d when data is written to the normal cells 1a, etc. To read data from the normal cells 1a, etc., the data is read from the flag cell 1d. From this data, it is determined whether the page data should be read is determined or not.

FIGS. 4A and 4B are diagrams showing an exemplary threshold voltage distribution in a memory cell that stores two level data. If data is erased from the memory cell, the threshold voltage of the memory cell is set to a negative value as shown in FIG. 4A. If the write data is “1,” it is not written to the memory cell, and the threshold voltage of the memory cell remains at the data-erased level as shown in FIG. 4A. If the write data “0,” it is written to the memory cell, and the threshold voltage of the memory cell rises to a positive value as shown in FIG. 4B.

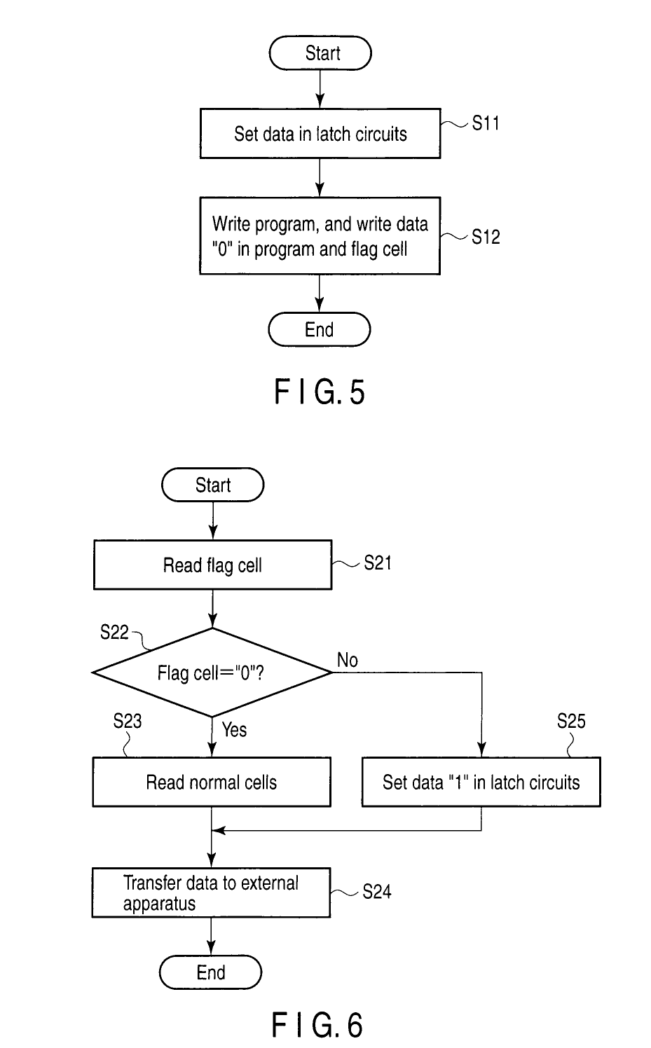

FIG. 5 schematically illustrates the data write process performed in the first embodiment. To write data, the data is first set in, for example, the LDL provided in the respective latch circuits 2b of the data storage circuits 10 1, 10 2, . . . , 10 n shown in FIG. 2. That is, to write data to any selected page, the data is set in the LDLs associated with the normal cells 1a, ECC cells 1b, and the redundancy cells 1c, and data “0” is set in the LDL associated with the flag cell 1d (S11).

Thereafter, the data write process is performed in accordance with the data set in the LDLs (S12). As a result, the data is written to the normal cells 1a, ECC cells 1b and redundancy cells 1c, and data “0” is written to the flag cell 1d.

This data write process is similar to the ordinary data write process. That is, a program voltage Vpgm is applied to the selected word lines, raising the threshold voltage of the cells for storing the write the data, which are connected to the bit lines set at, for example, voltage Vss. Then, verification is performed, determining whether the threshold voltage of the cells have reached the predetermined verification level. If the threshold voltage of the cells to which to write the data has not reached the verification level, the program voltage Vpgm is increased a little, and the data write process is performed again. This sequence of steps is repeated until the threshold voltage of the cells reaches the verification level.

The data is thereby written to the normal cells 1a, etc, and data “0” is written to the flag cell 1d. The flag cell 1d of the page to which no data is written remains “1.”

FIG. 6 illustrates a data read process performed in the first embodiment. To read data, the data held in the flag cell 1d is checked, determining whether the data has been written (S21). That is, the only the bit line connected to the flag cell 1d is charged, while any other bit lines are not charged. Only the data the flag cell 1b holds is thereby read first. Any bit line is charged or not charged by controlling the sense amplifier 2a.

The data is thus read from the flag cell 1d, by applying, for example, a read-level voltage AR (shown in FIG. 4A) to the selected word lines, while electrically charging only the bit line connected to the flag cell 1d. If the flag cell 1d holds data “0,” it is in off state, and the bit line remains at charged level (high level). If the flag cell 1d holds no data, it is in on state, and the bit line is discharged to low level. The potential of the bit line is detected by the sense amplifier 2a that is connected to the bit line.

If the bit line is at high level (data “0”), the output signal of the sense amplifier 2a falls to low level, whereby data “0” is latched in, for example, whereby the LDL of the latch circuit 2b. If the bit line is at low level (data “1”), the output signal of the sense amplifier 2a rises to high level, whereby data “1” is latched in, for example, the LDL of the latch circuit 2b.

Next, it is determine whether the data held in the LDL of the latch circuits 2b is “0.” In other words, whether the data in the flag cell is “0” is determined (S22). If the data in the flag cell is “0,” or if data has been written to the page, the page will be read in the ordinary manner. More precisely, each bit line for the page is charged, applying the read-level voltage AR to the word lines, whereby the data is read from each cell to the bit line (S23). The data detected by the sense amplifier 2a connected to the bit line is latched in, for example, the LDL of the latch 2b. The data latched in the LDL is output through the XDL of the latch 2b from the data storage circuit (S24).

In Step S22, the data in the flag cell 1d may be determined to be “1.” That is, no data may be found to be stored in the flag sell 1d. If this is the case, the page is not read, and the data “1” is set in, for example, the XDL of the latch 2b (S25). The data in the XDL is output from the data storage circuit (S24). That is, any page for which the data in the flag cell 1d has been determined to be “1” is not read at all, and data “1” is set in the XLD of each latch circuit 2b and then output therefrom.

In the first embodiment described above, a flag cell 1d is provided in each page, whether data is written to the page or not is determined, and the data is read from the flag cell 1d when the data is read. If the data thus read shows that no data is written to the page, all “1” are output without performing a read process on the page. Thus, any page in which no data is written is not read. This can reduce the power consumption.

Since any page in which no data is written is output, without being read, the data can be output at high speed.

In the first embodiment described above, the flag cell 1d holds one bit of data. Nonetheless, the flag cell 1d is not limited to one that holds one bit. The flag cell 1d may be configured to hold a plurality of bits, such as one byte. In this case, data “0” is written to the flag cells 1d in order to write data to the normal cells 1a. Not to write data to the normal cells 1a, the data “1” is maintained in the flag cells 1d. In order to read data from the normal cells 1a, data is first read from the flag cells 1d, and the data the flag cells 1d hold is discriminated in accordance with majority. This can help to enhance the reliability of the data stored in the flag cells 1d.

### Second Embodiment

The first embodiment has been described, in which two level data (1 bit) is stored in one memory cell. In the second embodiment, four level data (2 bits) is stored in one memory cell.

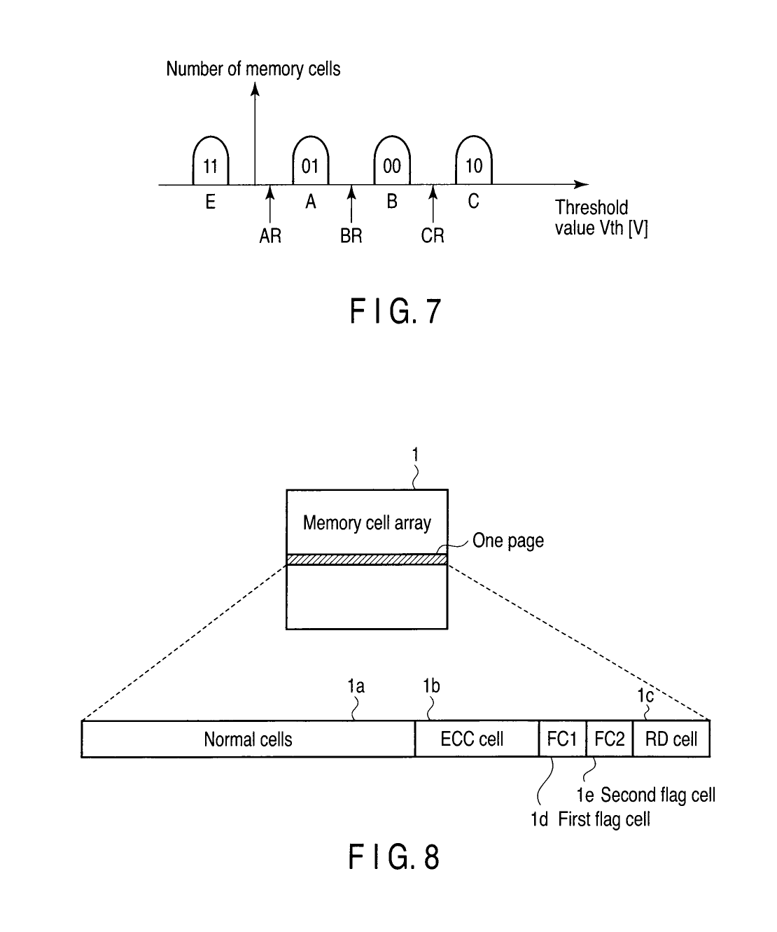

FIG. 7 shows an exemplary threshold voltage distribution in a memory cell that stores four level data. Of two bits, the lower bit is defined as lower page (first page), and the higher bit as upper page (second page). Data “11” (in erased state) is defined as level E, data “01” as level A, data “00” as level B, and data “10” as level C. Voltage levels (read levels) used to determine these levels E, A, B and C, respectively, are AR, BR and CR.

FIG. 8 shows an exemplary page configuration used to store four level data. In FIG. 8, the same elements as shown in FIG. 3 are designated by the same reference numbers.

The four level data is composed of a lower page and an upper page. Either page has a first flag cell (FC1) 1d and a second flag cell (FC2) 1e. The first flag cell 1d indicates whether the lower page is written or not. The second flag cell 1e indicates whether the upper page is written or not. More specifically, if the data held in the first flag cell 1d is “0,” it indicates that data is written to the lower page. Likewise, if the data held in the second flag cell 1e is “0,” it indicates that data is written to the upper page. If the data held in the first flag cell 1d is “1,” it indicates that no data is not in the lower page. If the data held in the second flag cell 1e is “1,” it indicates that no data is written to the upper page. The data is written, first to the lower page, and then to the upper page. In some cases, only the lower page may be written and the upper page is not written at all.

The first flag cell 1d and the second flag cell 1e are not limited to those which hold one bit each. For example, the flag cells 1d and 1e may hold, for example, one byte each, as will be described later herein.

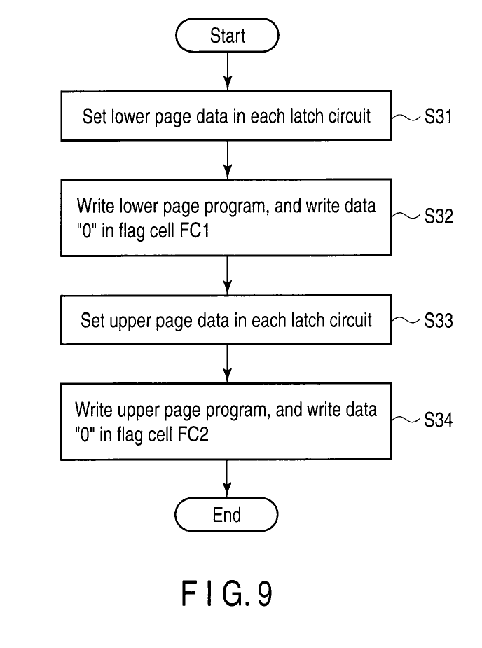

FIG. 9 schematically illustrates a process of writing four level data, performed in the second embodiment. In order to write data, the data to write to, for example, the lower page is set in the LDLs of the latch circuits 2b of the data storage circuits 10 1, 10 2, . . . , 10 n shown in FIG. 2. That is, to write data to the lower page, necessary data items are set in the LDLs associated with the normal cells 1a, EEC cells 1b and redundancy cells 1c, data “0” is set in the LDL associated with the first flag cell 1d, and data “1” is set in the LDL associated with the second flag cell 1e (S31).

Thereafter, a process of writing data to the lower page is performed in accordance with the data items set in the LDLs, respectively (S32). As a result, the data is written to the normal cells 1a, ECC cells 1b and redundancy cells 1c, data “0” is written to the flag cell 1d, and no data is written to the second flag cell 1e. Note that this data write process is similar to the process performed in the first embodiment.

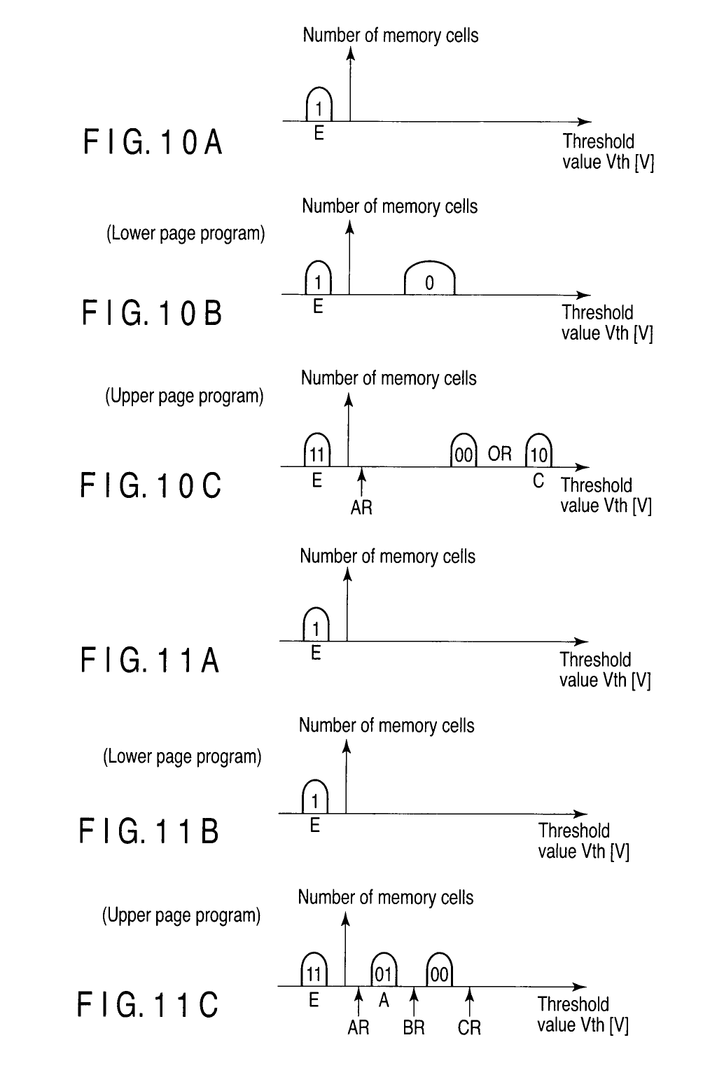

FIGS. 10A, 10B and 10C show exemplary threshold voltage distribution in the first flag cell 1d. FIG. 11A shows exemplary threshold voltage distribution in the second flag cell 1e. As shown in FIG. 10A, the first flag cell 1d is at level E (negative threshold voltage) in an erased state. While the first flag cell 1d remains in this state, data “0” may be written to it. In this case, the threshold voltage is set to a value between levels A and B shown in FIG. 7, as is shown in FIG. 10B.

When the lower page is written, the threshold voltage of the second flag cell 1e does not change, as is seen from FIGS. 11A and 11B. It remains in the erased state (at level E).

Thereafter, the data of the upper page is set in, for example, in the LDLs of the latch circuits 2b. That is, necessary data items are set in the LDLs associated with the normal cells 1a, EEC cells 1b and redundancy cells 1c, and data “1” is set in the LDL associated with the first flat cell 1d, and data “0” is set in the LDL associated with the second flag cell 1e (S33).

Then, the upper page is written in accordance with the data set in the LDLs (S34). As a result, the data is written to the normal cells 1a, ECC cells 1b and redundancy cells 1c, and data “0” is written to the second flag cell 1e, and no data is written to the first flag cell 1d.

Now that the upper page has been written, the voltage on the first flag cell 1d changes to the threshold voltage of level C as shown in FIG. 10C, and the voltage on the second flag cell 1e changes to the threshold voltage of level A or B as shown in FIG. 11C. That is, in the second flag cell 1e, the data of the lower page is set to “0” or “1” when data “0” is written to the upper page.

As the lower and upper pages are written so, the threshold voltages of the first and second flag cells 1d and 1e are set.

The writing to the upper page is not performed when there is not necessity of writing, and data may be written to only the lower page. In this case, the threshold voltage of the first flag cell 1d is set to level B, as indicated by data 00 in FIG. 10C. The data in the first flag cell 1d is thus set as a threshold voltage of level B or level C.

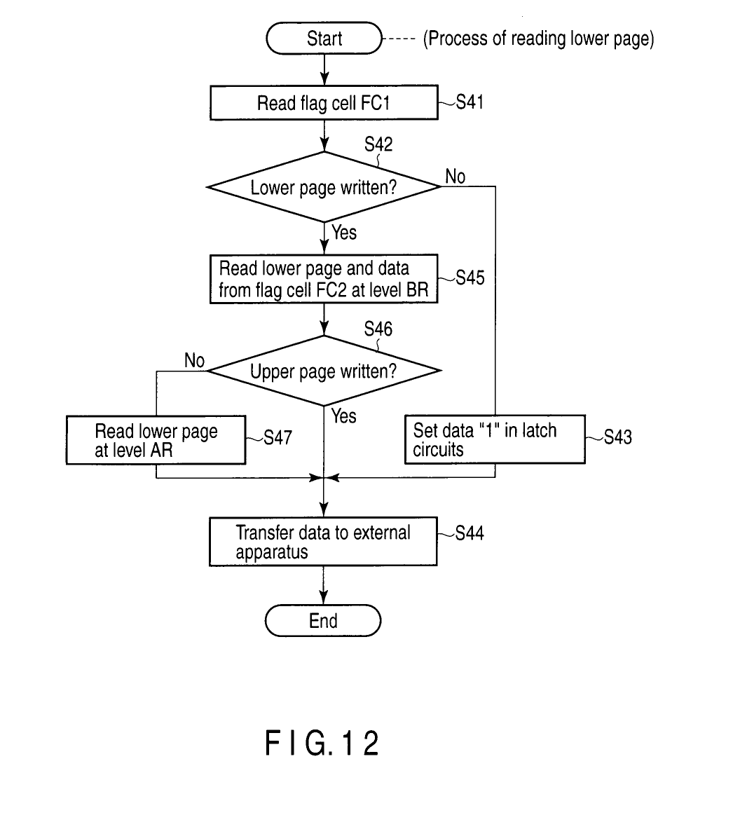

FIG. 12 schematically illustrates a process of reading four level data in the second embodiment. To be more specific, FIG. 12 shows how four level data is read from the lower page.

First, the data is read from the first flag cell (FC1) 1d only, as in the first embodiment (S41). That is, any word line selected is set to read level AR, whereby the data held in the first flag cell (FC1) 1d is read out (S41). That is, a voltage of read level AR is applied to the word line selected, and the data held in the first flag cell 1d is read. If the data of the lower page has been written, the threshold voltage of the first flag cell (FC1) 1d is set to level B or level C. Therefore, if its threshold voltage is higher than read level AR, the first flag cell 1d holds data. Hence, data “0,” for example, is set in, for example, the LDLs of the latch circuits 2b. If its threshold voltage is lower than read level AR, data is not written to the first flag cell (FC1). In this case, data “1,” for example, is set in the LDLs of the latch circuits 2b.

Next, whether the data read from the first flag cell 1d is “0” is determined (S42). If the data read from the first flag cell 1d is “1,” since data has not written to the lower page, the data of the lower page will not be read, and data “1” is set in the XDL of each latch circuit 2b (S43), and the data in the XDL is output to an external apparatus (S44).

If the data read from the first flag cell 1d is “0,” it shows that the data of the lower page has been written. Therefore, the data of the lower page is read. When the data of the lower page is read, the data in the second flag cell (FC2) 1e is read, too (S45). That is, the data of the lower page and the data of the second flag cell 1e are read at read level BR. The data of the lower page and the data of the second flag cell 1e, thus read, are latched in, for example, the LDL of the latch circuit 2b incorporated in the associated data storage circuit. If the data of the lower page and the threshold voltage of a cell for writing level B of the second flag cell 1e are higher than read level BR, data “0,” for example, will be latched in the LDL. If the data of the lower page and the threshold voltage of the second flag cell 1e are lower than read level BR, data “1,” for example, will be latched in the LDL.

Thereafter, whether the upper page has been written is determined from the data of the second flag cell 1e, which is latched in the LDL of the latch circuit 2b (S46). If the data of the second flag cell 1e is “0,” it indicates that the data of the upper page has been written. The data in the LDL, which has been read at read level BR, is therefore transferred to the XDL and then output to the exterior (S44).

If the data of the second flag cell 1e is found to be “1” in Step 46, it indicates that the data of the upper page has not been written. In this case, the data of the lower page is read at read voltage AR (S47). The data, thus read, is transferred through the XDL to the exterior (S44)

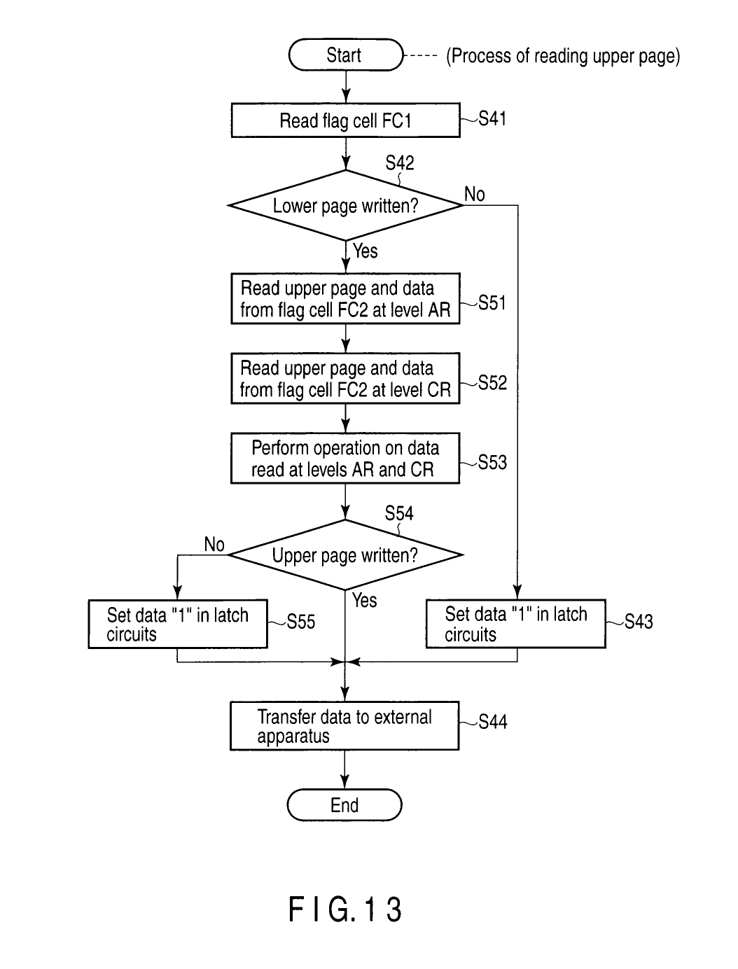

FIG. 13 illustrates a different process of reading the upper page. In FIG. 13, the same steps as shown in FIG. 12 are designated by the same reference numbers.

In the process of reading the upper page, the data in the first flag cell 1d is first read as described above (S41), and it is then determined whether the lower page has been written (S42). If the lower page is found not written, the upper page has not been written, either. In this case, data “1” is set in the XDL of each latch circuit 2b (S43). This data “1” is output to the exterior (S44).

In Step S42, the lower page may be found to have been written. If this is the case, the page of the upper page and the data in the second flag cell (FC2) 1e are read at read level AR (S51). Further, the data of the upper page and the data in the second flag cell (FC2) 1e are read at read level CR (S52). The data read at read level AR is latched in, for example, the LDL of each latch circuit 2b, and the data read at read level CR is latched in, for example, UDL o each latch circuit 2b.

Thereafter, the operation circuit performs an operation on the data read at read level AR and the data read at read level CR (S53). If the result of this operation shows that the data read at read level AR and the data read at read level CR are “0” and “1,” respectively, the data of the upper page is set to “0.” If the result of this operation shows that the data read at read level AR and the data read at read level CR are “1” and “0,” respectively, the data of the upper page is set to “1.” The result of the operation is latched in, for example, each XDL.

Next, whether the upper page has been written is determined from the data in the second flag cell 1e, which has been read at the above-mentioned two read levels (S54). More precisely, the upper page is found to have been written if the data in the XDL associated with the second flag cell 1e is “0,” and not to have been written if the data in the XDL associated with the second flag cell 1e is “1.” If the upper page is found to have been written, the data latched in the XDL is transferred to the exterior (S44).

If no data is found to have been written to the upper page, data “1” is set in the XDL (S55). This data is transferred to the exterior (S44).

In the second embodiment described above, the first flag cell 1d and the second flag cell 1e are used, the former holds data showing whether the lower page has been written, and the latter holds data showing whether the upper page has been written. To write data, data is set in the first and second flag cells 1d and 1e. In preparation for data reading, it may be determined, from the data held in the first flag cell 1e, that the data of the lower page has not been written. In this case, all “1” are output without reading the lower page. This can reduce the power consumption.

Before reading the upper page, it may be determined, from the data held in the first flag cell 1d, that the lower page has not been written. If this is the case, it is determined that the upper page has not been written, either. Therefore, all “1” are output without reading the lower page. This can reduce the power consumption. Hence, the power consumption can be decreased.

Thus, if neither the data of the lower page nor the data of the upper page has been written, all “1” are output, without reading the lower page and the upper page. Data can therefore be read at high speed.

### Third Embodiment

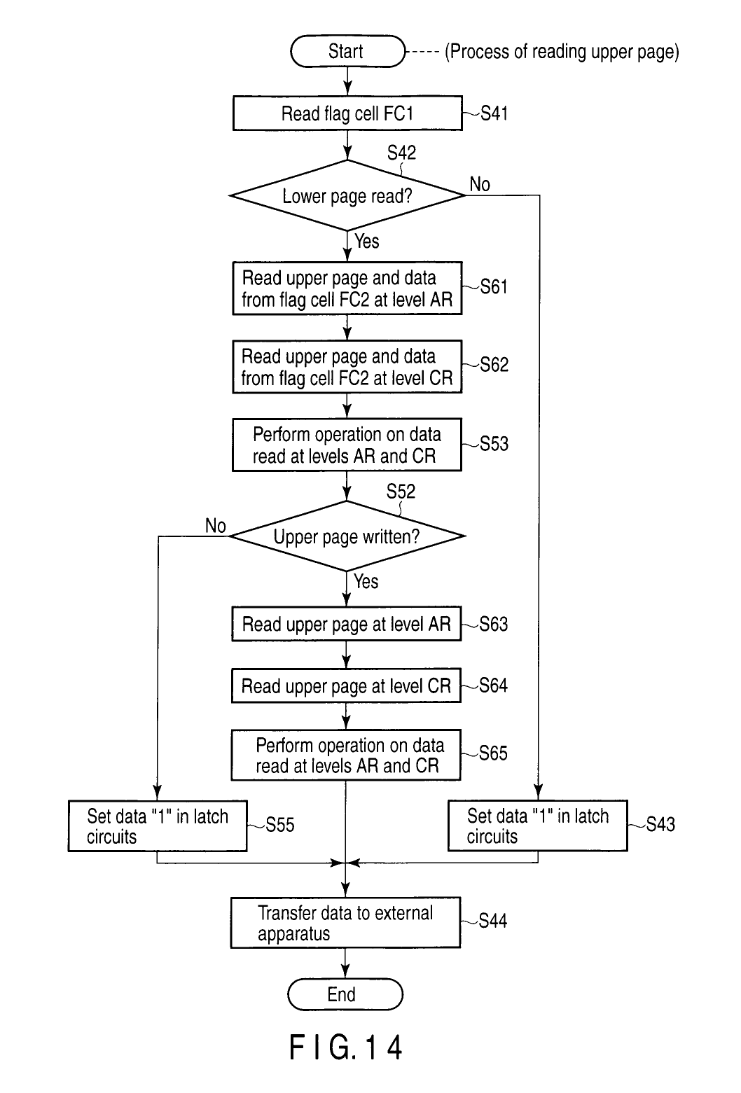

FIG. 14 illustrates a third embodiment. The third embodiment is a modification of the second embodiment, different from the second embodiment in the process of reading the upper page. In FIG. 14, the same steps as shown in FIG. 13 are designated by the same reference numbers. Only the steps characterizing the third embodiment will be explained below.

In order to read the upper page, it is first determined whether the lower page has been written (S41 and S42). If the lower page is found to have been written, in the second embodiment, the data in the upper page and the second flag cell (FC2) 1e is read at read level AR or CR. In contrast, in third embodiment, If the lower page is found to have been written, the data in the upper page is not read and only read the data in the second flag cell (FC2) 1e at read level AR or CR (S61 and S62). The data read from the second flag cell (FC2) 1e are latched in, for example, the LDL and UDL.

The operation circuit performs an operation on data in the second flag cell 1e, which has been latched in the LDL and UDL (S53). If the result of this operation shows that the data read at read level AR and the data read at read level CR are “0” and “1,” respectively, the data of the upper page is set to “0.” If the result of this operation shows that the data read at read level AR and the data read at read level CR are “1” and “0,” respectively, the data of the upper page is set to “1,” and the data read at of the upper page is set to “1.” The result of the operation is latched in, for example, each XDL. The result of this operation is latched in, for example, each XDL.

Next, whether the upper page has been written is determined from the data in the second flag cell 1e, which has been read at two read levels (S52). That is, if the data in XDL associated with the second flag cell 1e is “0,” the upper page is found to have been written, and if the data in XDL associated with the second flag cell 1e is “1,” the upper page is found not to have been written.

If the upper page is found to have been written, the data of the upper page is sequentially read at read levels AR and CR (S63, S64). The data read at read level AR is latched in, for example, the LDL, and the data read at read level CR is latched in, for example, the UDL.

Thereafter, the data latched in the LDL and the data latched in the UDL are subjected to an operation (S65). This operation is similar to the operation performed in Step S53. The result of the operation is latched in, for example, the XDL and will be transferred to the exterior (S44).

In Step S52, the upper page may be found not to have been written. In this case, “1” is set in each XDL (S55). This data is then transferred to the exterior (S44).

The third embodiment can achieve the same advantage as the second embodiment. Further, the third embodiment reads only the data items in the first and second flag cells 1d and 1e, not reading the data of the upper page, if the data of the lower page is found to have been written, and reads the data of the upper page if the data items in the first and second flag cells 1d and 1e show that the data of the upper page has been written. Therefore, unnecessary reading of the upper page is prevented, ultimately reducing the power consumption.

In the second and third embodiments, the first flag cell 1d and second flag cell 1e hold one bit of data each. Nonetheless, they are not limited to the type that holds one bit. The first flag cell 1d and second flag cell 1e may be configured to hold a plurality of bits each, such as one byte. In this case, the data in the first flag cell 1d is read, obtaining majority, and the data in the second flag cell 1e is read, obtaining majority. From the majorities thus obtained, whether the lower page and the upper page have been written or not can be determined. If the memory cell array 1 is so configured, whether the lower page and the upper page have been written can be determined at higher reliability.

As indicated above, the first embodiment is configured to store two level data, and the second embodiment is configured to store four level data. These embodiments are not limited to these configurations. The embodiments can be applied to a semiconductor memory device in which the number of flag cells is increased in accordance with the number of pages, thereby to store eight level data or data based on a greater number.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor memory device comprising:
a memory cell array having a plurality of memory cells arranged in a matrix pattern, the memory cells connected to a plurality of words lines and a plurality of bit lines; and
a control circuit configured to control a data write process and a data read process with respect to the plurality of memory cells,
wherein the control circuit sets a first flag data in a second memory cell in order to write data to a plurality of first memory cells of memory cell array, the second memory cell having been selected at the same time as the first memory cells, determines whether the first flag data is set in the second memory cell before data is read from the first memory cells, and reads no data from the first memory cells and outputs data of first logic level if the first flag data is not set in the second memory cell, and reads data from the first memory cells if the first flag data is set in the second memory cell.

2. The device according to claim 1, wherein the second memory cell is constituted by a plurality of memory cells, and the majority of data items read from the memory cells determines the first flag data.

3. The device according to claim 1, wherein the plurality of memory cells store one bit of data.

4. A semiconductor memory device comprising:
a memory cell array having a plurality of memory cells arranged in a matrix pattern, the memory cells connected to a plurality of words lines and a plurality of bit lines; and
a control circuit configured to control a data write process and a data read process with respect to the memory cells,
wherein the control circuit sets a first flag data in a second memory cell in order to write the data of a first page in first memory cells of memory cell array, the second memory cell having been selected at the same time as the first memory cells; the control circuit sets a second flag data in a third memory cell in order to write the data of a second page in the first memory cells, the third memory cell having been selected at the same time as the first memory cells; the control circuit determines whether the first flag data is set in the second memory cell before the data of the first page is read from the first memory cells, reads no data from the first memory cells and outputs data of first logic level if the first flag data is not set in the second memory cell, and reads the data of the first page from the first memory cells if the first flag data is set in the second memory cell; and the control circuit determines whether the first flag data is set in the second memory cell before the data of the second page is read from the first memory cells, reads no data of the second page and outputs the data of first logic level if the first flag data is not set in the second memory cell.

5. The device according to claim 4, wherein the control circuit reads the data of the second page and the data in the third memory cell if the first flag data is set in the second memory cell, determines whether the second flag data is set in the third memory cell, outputs the data of the second page if the second flag data is set in the third memory cell, and outputs the data of first logic level if the second flag data is not set in the third memory cell.

6. The device according to claim 4, wherein the control circuit reads the data in the third memory cell if the first flag data is set in the second memory cell, determines whether the second flag data is set in the third memory cell, outputs the data of the second page if the second flag data is set in the third memory cell, and outputs the data of first logic level if the second flag data is not set in the third memory cell.

7. The device according to claim 4, wherein the second memory cell is composed of a plurality of memory cells, and the first flag data is determined by majority of the data items read from the memory cells.

8. The device according to claim 4, wherein the third memory cell is composed of a plurality of memory cells, and the second flag data is determined by majority of the data items read from the memory cells.

9. A method of controlling a semiconductor memory device, comprising:
setting a first flag data in a second memory cell in order to write data to a plurality of first memory cells of a memory cell array, the second memory cell having been selected at the as the first memory cells; and
determining whether the first flag data is set in the second memory cell before data is read from the first memory cells, and reading no data from the first memory cells and outputs data of first logic level if the first flag data is not set in the second memory cell, and reading data from the first memory cells if the first flag data is set in the second memory cell.

10. The method according to claim 9, wherein the second memory cell is composed of a plurality of memory cells, and the first flag data is determined by majority of the data items read from the memory cells.

11. The method according to claim 9, wherein the plurality of memory cells store one bit of data.
